(19) United States
(12) Patent Application Publication
(10) Pub. No.: US 2005/0233066 A1
(43) Pub. Date: Oct. 20, 2005

(54) Manufacturing method of chemical battery electrode and battery

(76) Inventors: Takuya Sunagawa, Naruto-city (JP); Yasuyuki Kusumoto, Kobe-city (JP); Shin Fujitani, Kobe-city (JP); Kensuke Nakatani, Sumoto-city (JP)

Correspondence Address: KUBOVCIK & KUBOVCIK, SUITE 710, 900 17TH STREET NW, WASHINGTON, DC, 20006, US

(21) Appl. No.: 11/108,846

(22) Filed: Apr. 19, 2005

(30) Foreign Application Priority Data
Apr. 20, 2004 (JP) 124738/2004

(51) Int. Cl. B05D 1/02; B05D 5/12; H01M 4/66; H01M 4/48; H01M 4/58; B05D 7/00

(52) U.S. Cl. 427/58; 427/421.1; 427/427; 429/245; 429/231.95

(57) ABSTRACT

A method of manufacturing a chemical battery electrode characterized in that active material particles are attached on a current collector comprising a step of dispersing active material particles in gas flow without melting nor evaporating it, a step of spraying the gas flow to the current collector so that the active material particles collide with the current collector, and a step of bonding the active material particles onto a surface of the current collector by the impact force.

### BACKGROUND OF THE INVENTION

1. Field of the Invention

The present invention relates to a manufacturing method of an electrode which is used in a chemical battery such as a primary battery and a secondary battery such as a lithium secondary battery, a nickel-cadmium battery, a nickel-hydrogen battery and the like, and a battery using the electrode.

2. Description of the Related Art

As the chemical battery, the primary battery in which only discharge can be performed, and the secondary battery in which charge and discharge can be performed are known. In addition, as the secondary battery, the nickel-cadmium battery, the nickel-hydrogen battery, the lithium secondary battery and the like are known. In a case where a particulate electrode active material is used in the above chemical battery, an electrode is manufactured while active material particles are held on a current collector in many cases. For example, the electrode is manufactured by dispersing a positive electrode active material or a negative electrode active material in an appropriate solvent together with a binder and a conductive material according to need to manufacture a slurry and applying this slurry to the current collector foil.

In the lithium secondary battery, silicon attracts the attention as the active material which can remarkably increase an energy density of the battery. As a method of manufacturing the electrode using such silicon particles, a manufacturing method in which the slurry comprising the silicon particles and a binder is prepared and this is applied to a surface of the current collector foil, and then sintered in a non-oxidizing atmosphere is disclosed (in International Publication WO02/21616 Pamphlet, for example).

In addition, as an electrode which is formed using such silicon as the active material and shows preferable charge and discharge cycle characteristics, an electrode comprising a silicon thin film formed on a current collector such as copper foil by sputtering method or CVD method is disclosed (in International Publication WO01/31720 Pamphlet, for example)

When the thin film is formed by the CVD method or sputtering method to manufacture the electrode, it is necessary to maintain a vacuum state in an apparatus and when many electrodes are manufactured, a large vacuum equipment is needed.

In addition, when active material particles are used, it is necessary to manufacture the slurry once, apply the slurry to the current collector and dry it as described above. In addition, it is necessary to roll it by a mill roll and the like after dried in some cases. Furthermore, in order to hold the active material particles on the current collector, the electrode has to contain the binder and the like which is not directly involved in an electrode reaction.

### SUMMARY OF THE INVENTION

It is an object of the present invention to provide a new manufacturing method by which a chemical battery electrode can be manufactured using active material particles without manufacturing a slurry, and a battery using the electrode.

The present invention provides a method of manufacturing the chemical battery electrode in which the active material particles are attached onto a current collector, characterized by comprising a step of dispersing the active material particles in gas flow without melting nor evaporating it, a step of spraying this gas flow to the current collector so that the active material particles collide with the current collector, and a step of bonding the active material particles on a surface of the current collector by impact force.

According to the present invention, the active material particles are bonded to the current collector surface by spraying the gas flow in which the active material particles are dispersed, to the current collector so that the active material particles collide with the current collector. As a method of spraying the particles with the gas flow, there is a so-called cold spray method. According to the cold spray method, metal, ceramic powder, or the like is dispersed in high-speed gas flow and the high-speed gas flow is sprayed onto a board so that the particles collide with the board at high speed and the particles are attached on the board. While a spray method is a method in which a material is melted and sprayed, the cold spray method is a method in which a material is sprayed on the board in a solid state. According to the cold spray method, for example, gas such as nitrogen, helium, or air which was heated to about 300 to 500° C. is introduced into a Laval nozzle (supersonic nozzle) to become supersonic flow and particles are put into this flow to be accelerated and then they collide with the board in the sold state. A collision speed of the particles can be 500 m/sec or more.

According to the present invention, as described above, the active material particles collide with the current collector and thus bonded to the surface of the current collector. Therefore, since the electrode can be manufactured without manufacturing the slurry and the like, manufacturing steps can be simplified as compared with the conventional one, so that productivity of the electrode can be improved.

In addition, according to the manufacturing method of the present invention, since the active material particles can be directly bonded on the current collector surface, current collection efficiency in the electrode can be improved and the active material can be more effectively used.

The present invention comprises the manufacturing method of the chemical battery electrode and as the chemical battery, the primary battery and the secondary battery are well-known as described above. Therefore, according to the present invention, both primary battery electrode and secondary battery electrode can be manufactured. As the secondary battery, the nickel-cadmium battery, the nickel-hydrogen battery, the lithium secondary battery and the like are well-known. The secondary battery electrode is the electrodes in which active material particles are attached onto the current collector and it is conventionally manufactured by applying the slurry containing the active material particles to the current collector. According to the present invention, the electrode can be manufactured without manufacturing the slurry in the manufacturing steps of the secondary battery electrode, so that the manufacturing steps are simplified and the productivity thereof can be improved.

As the active material particle used in the present invention, it is not particularly limited as long as it can be used in the chemical battery. For example, there is a particle formed of metal, a semiconductor or a metal oxide. In addition, the metal oxide comprises a metal hydroxide. In the case of the nickel-cadmium battery and the nickel-hydrogen battery, as the active material, nickel hydroxide, cadmium hydroxide, a hydrogen storing alloy or the like is used. Therefore, as the active material particles when the electrode of the above battery is manufactured, there are nickel hydroxide powder, cadmium hydroxide power, hydrogen storing alloy powder or the like.

In the case of the lithium secondary battery, a material which stores and discharges lithium is used as the active material. As the negative electrode active material, a material which can be alloyed with lithium or a carbon material is used. As a material which is alloyed with lithium, there are silicon, germanium, tin, lead, zinc, magnesium, sodium, aluminum, gallium, indium and an alloy of them. Silicon is preferably used in view of large charge and discharge capacity. As an active material particle containing silicon as a main component, there are a silicon free particle, a silicon alloy particle, for example. As the silicon alloy particle, alloy particle containing a silicon 50 atom % or more is preferably used. As the silicon alloy, there are an Si—Co alloy, an Si—Fe alloy, a Si—Zn alloy, a Si—Zr alloy, for example.

In addition, when the positive electrode active material of the lithium secondary battery is used as the active material particle, there are a particle of a transition metal oxide containing lithium such as a lithium cobalt oxide, a lithium nickel oxide, a lithium manganese oxide, and a particle of a metal oxide which does not contain lithium such as a manganese oxide, for example. In addition, any kinds of particles other than the above can be used without any limitation as long as they are particles and can be used as the positive electrode active material of the lithium secondary battery.

According to the present invention, various kinds of active material particles may be mixed and used as the active material particle. More specifically, different kinds of active material particles can be mixed and used. For example, in the case of the lithium secondary battery electrode, silicon particles and tin particles may be mixed and used.

In addition, according to the present invention, the active material particles and particles which are not an active material may be mixed and used. For example, in the case of the lithium secondary battery electrode, silicon particles and copper particles, or the silicon particles and cobalt particles may be mixed and used, for example.

When the surface of the current collector is formed of a material having ductility and/or malleability, the current collector surface is plastically deformed by impact force and receives the active material particles when the active material particles collide with the current collector surface, whereby the active material particles are bonded on the current collector surface. When the active material particles are not the material which has the ductility and/or malleability, when the current collector surface is covered with the active material particles, since the surface of the active material particle is not plastically deformed, the newly impinging active material particle is not attached thereon and falls down after impinging on the surface. Therefore, when the only the active material particle formed of the material which does not have the ductility and/or the malleability is used, the electrode in which only one layer of the active material particles is attached on the current collector surface can be manufactured. Thus, an amount of the active material particles attached on the current collector can be controlled by adjusting a diameter of the active material particle.

In addition, when the active material particles or the particles which are not the active material is mixed and used as described above, as the active material particles or the particles which are not the active material, particles formed of the material having the ductility and/or malleability so as to be plastically deformed by the impact force can be used. Since such particles can be plastically deformed by the impact force, they can bind the particles which are not plastically deformed. Therefore, since such particles function as binders, the active material particles can be deposited so as to be laminated on the current collector surface. Thus, two or more particle layers can be formed on the current collector surface.

As the particle having the ductility and/or malleability, there are tin, copper, magnesium, iron, cobalt, nickel, zinc, aluminum, germanium, indium and the like. Among the above, tin, magnesium, zinc, aluminum, germanium and indium can be used as the active material particle of the lithium secondary battery. In addition, copper, iron, cobalt, and nickel can be used in the lithium secondary battery as the particle which is not the active material.

In addition, according to the present invention, it is preferable that at least the surface of the current collector is formed of the material having the ductility and/or malleability so as to be plastically deformed by the impact force as described above. When the current collector surface can be plastically deformed by the impact force, the active material particles can be firmly bonded to the current collector surface. As the material having the ductility and/or the malleability, there are copper, magnesium, iron, cobalt, nickel, zinc, aluminum, germanium, indium and the like.

When silicon or the silicon alloy particle is used as the active material particle, since silicon and copper are likely to form a solid solution and copper has the ductility and/or the malleability so as to be plastically deformed, it is preferable that at least the surface of the current collector is formed on copper or a copper alloy.

According to the present invention, it is preferable that the surface of the current collector is roughened. When the surface of the current collector is roughened, since an area of the current collector surface can be increased, the amount of the attached active material particles can be increased. When the surface roughened current collector is used, arithmetic average roughness Ra of the current collector surface is preferably 0.1 μm or more and it is further preferably 0.1 to 2 μm. The arithmetic average roughness Ra is defined in Japanese Industrial Standards (JIS B 0601-1994). The arithmetic average roughness Ra can be measured by a surface roughness measuring machine, for example.

According to the cold spray method, the high-speed gas flow is generated by discharging gas from the nozzle as described above. Therefore, when the gas is heated, since great thermal energy can be converted to kinetic energy of the gas, more high-speed gas flow can be generated. As a result, more kinetic energy can be applied to the particles. Therefore, according to the present invention, when the cold spray method is used, it is preferable that the gas which forms the gas flow is heated.

When the particles collide with the board at high speed, the kinetic energy of the particles is converted to binding energy and thermal energy. A temperature of the current collector serving as the board is raised by the thermal energy. Since an optimal temperature when the particles are attached on the current collector depends on the kinds of the current collector and the particle, it is preferable that the temperature of the current collector is controlled in order to effectively attach the particles.

In addition, the particles could be oxidized when they collide with the current collector because they are heated up. Therefore, it is preferable that the gas which forms the high-speed gas flow is inert gas which does not substantially contain oxygen or oxidizing gas.

In addition, when the gas which forms the high-speed gas flow contains reducing gas such as hydrogen, the particles are more effectively prevented from being oxidized. Therefore, the gas which forms the high-speed gas flow may contain the reducing gas.

When there is no possibility that the particles are oxidized, air can be used for the gas which forms the high-speed gas flow. It is preferable to use air in view of cost.

Although a particle diameter of the active material particle is particularly limited in the present invention, it is preferably 30 μm or less as an average particle diameter and it is more preferably in a range of 0.01 to 20 μm. Furthermore, a maximum particle diameter of the active material particle is preferably 50 μm or less and it is more preferably 30 μm or less.

The battery of the present invention is characterized by using the electrode manufactured by the above method according to the present invention.

As the battery of the present invention comprises the primary battery and the secondary battery as described above. As the secondary battery, there are the nickel-cadmium battery, nickel-hydrogen battery, lithium secondary battery and the like. When the present invention is applied to the lithium secondary battery electrode, the positive electrode may be manufactured or the negative electrode may be manufactured according to the present invention. As the active material particle of the positive electrode and the active material particle of the negative electrode, there are those as described above. In addition, as a solvent and a solute of nonaqueous electrolyte, the following can be used.

Although a non-aqueous electrolyte solvent for use in the lithium secondary battery is not particularly limited, examples thereof may include cyclic carbonates such as ethylene carbonate, propylene carbonate, butylene carbonate and vinylene carbonate, chain carbonates such as dimethyl carbonate, methyl ethyl carbonate and diethyl carbonate. In the case where the cyclic carbonate is present in the the non-aqueous electrolyte solvent, the cyclic carbonate is preferably used on the active material particle surface since it particularly easily forms a high quality coating film with excellent lithium ion conductivity. In particular, ethylene carbonate and propylene carbonate are preferably used. Moreover, a mixed solvent of the cyclic carbonate and the chain carbonate can be preferably used. Such a mixed solvent particularly preferably contains ethylene carbonate or propylene carbonate and diethyl carbonate.

Further, mixed solvents of the above-mentioned cyclic carbonate and an ether solvent such as 1,2-dimethoxyethane or 1,2-diethoxyethane, or a chain ester such as y-butyrolactone, sulfolane or methyl acetate, can also be cited as examples.

Moreover, as examples of a non-aqueous electrolyte solute, LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀, Li₂B₁₂Cl₁₂, and the like, and mixtures thereof can be cited. In particular, the following solutes are preferably used: LiXF_{y} (where X is P, As, Sb, B, Bi, Al, Ga or In; y is 6 when X is P, As or Sb, and y is 4 when X is B, Bi, Al, Ga or In) and lithium perfluoroalkylsulfonateimide, LiN(CₘF₂ₘ₊₁SO₂) (CₙF₂ₙ₊₁SO₂) (where m and n are each independently integers of 1 to 4), or lithiumperfluoroalkylsulfonatemethide, LiC (CₚF₂ₚ₊₁SO₂)(C_{q}F_{2q+1}SO₂) (CᵣF₂ᵣ₊₁SO₂) (where p, q and r are each independently integers of 1 to 4). Among them, LiPF₆ is particularly preferably used. Further, as examples of the electrolyte, a gel polymer electrolyte obtained by impregnating a polymer electrolyte such as polyethylene oxide or polyacrylonitrile with an electrolytic solution, and an inorganic solid electrolyte such as LiI and Li₃N can be cited. The electrolyte of the lithium secondary battery can be used without a limitation so long as the lithium compound as the solute for expressing ion conductivity and the solvent where this compound is dissolved and maintained are not decomposed due to voltage during charge, discharge or storage of the battery.

According to the present invention, the chemical battery electrode can be manufactured using the active material particles without manufacturing the slurry and the like. Therefore, the manufacturing method can be such that the manufacturing steps are simplified and the productivity is excellent.

### BRIEF DESCRIPTION OF THE DRAWINGS

FIG. 1 is a schematic view showing a device in cold spraying method used in examples according to the present invention.

FIG. 2 is a plan view showing a scanning path of a spray gun on a current collector in the examples according to the present invention.

FIG. 3 is a plan view showing an EPMA image of Si on a surface of an electrode produced in an example according to the present invention.

FIG. 4 is a plan view showing an EPMA image of Cu on the surface of the electrode produced in the example according to the present invention.

FIG. 5 is a view showing an FIB-SIM image of the cross section of the electrode produced in the example according to the present invention.

FIG. 6 is an enlarged view of FIG. 5.

FIGS. 7(a) and (b) are schematic sectional views for explaining a state of bonding of active material particles to a current collector surface by a production method according to the present invention.

FIG. 8 is a schematic sectional view showing a beaker cell produced in the example according to the present invention.

FIG. 9 is a sectional view showing an FIB-SIM image of a cross section of an electrode produced in an example according to the present invention.

FIG. 10 is an enlarged view of FIG. 9.

FIG. 11 is a view showing charge/discharge curves at the first cycle of the beaker cells produced in Example 1 and Example 2 according to the present invention.

FIG. 12 is a view showing changes in discharge capacity with cycles of the beaker cells produced in Example 1 and Example 2 according to the present invention.

FIG. 13 is a view showing an XRD pattern prior to charge/discharge cycles in Example 1 according to the present invention.

FIG. 14 is a view showing an XRD pattern after the charge/discharge cycles in Example 1 according to the present invention.

FIG. 15 is a view showing an XRD pattern prior to charge/discharge cycles in Example 2 according to the present invention.

FIG. 16 is a view showing an XRD pattern after the charge/discharge cycles in Example 2 according to the present invention.

FIG. 17 is a view showing a SIM image of the surface of the electrode after the charge/discharge cycles in Example 1 according to the present invention.

FIG. 18 is a view showing an FIB-SIM image of the cross section of the electrode after the charge/discharge cycles in Example 1 according to the present invention.

FIG. 19 is a view showing a SIM image of the surface of the electrode after the charge/discharge cycles in Example 2 according to the present invention.

FIG. 20 is a view showing an FIB-SIM image of the cross section of the electrode after the charge/discharge cycles in Example 2 according to the present invention.

### DETAILED DESCRIPTION OF THE PREFERRED EMBODIMENTS

Below, the present invention is described in further detail based upon examples. However, the following examples do not limit the present invention, and can be appropriately modified and then implemented within the scope where the spirits of the present invention remain unchanged.

FIG. 1 is a schematic sectional view showing the surface structure of the electrode for a lithium secondary battery according to the first aspect of the present invention. A concave portion 1a is formed on the surface of a current collector 1. A bottom of an active material particle 2 is in the state of being imbedded in the concave potion 1a. The active material particle 2 is in direct contact with the surface of the current collector 1, inside the concave portion 1a. On the periphery of the concave portion 1a, a convex portion 1b is present which was formed at the time when the concave portion 1a was formed.

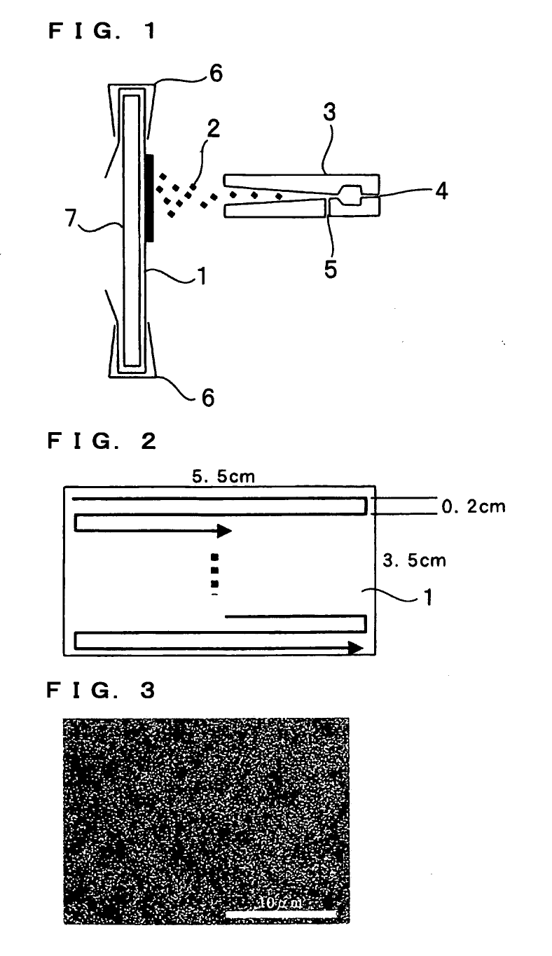

FIG. 2 is a schematic sectional view showing a surface structure of the electrode for a lithium secondary battery according to the second aspect of the present invention. As shown in FIG. 2, the concave portion 1a is formed on the surface of the current collector 1 in a state where the active material particle 2 in the lowest layer is imbedded in the concave portion 1a. A second particle layer 21 is arranged on a first particle layer 20 comprising the active material particles 2 in a state where the bottom of the active material particle 2 is imbedded in the concave portion 1a on the surface of the current collector 1. In the present example, the second particle layer 21 is formed of the active material particles 2 and another kind of particles 22. Another kind of particle 22 is made of a material having ductility and/or malleability so as to be plastically deformed and binds the active material particles 2, thus serving as a binder for binding the active material particles 2 in the second particle layer 21. In Example 3 described later where a mixture of silicon particles and tin particles is sprayed by cold spraying method onto the current collector surface to be deposited thereon, the tin particle performs the same function as that of another kind of particle 22.

### EXPERIMENT 1

### EXAMPLE 1

[Production of Electrode by Cold Spraying Method, Using Silicon as Active Material]

Using crystalline silicon particles (average particle size: 2.5 μm) as the active material particles, and an electrolytic copper foil (thickness: 35 μm, arithmetic average roughness Ra: 1.46 μm) as the current collector, the silicon particles were brought into collision with the glossy surface of the electrolytic copper foil which was the opposite side to the roughed surface of the foil by cold spraying method, to produce an electrode. Specifically, a device for cold spraying shown in FIG. 1 was used to produce the electrode. As shown in FIG. 1, the current collector 1 made of the electrolytic copper foil was wrapped around a support plate 7 made of a copper plate with a thickness of 2 mm, each end of which was then fixed with a clip 6. The current collector 1 was wrapped around the support plate 7 with the glossy surface of the electrolytic copper foil turned outside. The support plate 7 was used for preventing the current collector 1 from being broken by the silicon particles 2 when sprayed onto the current collector 1 by a high-speed air current.

A spray gun 3 was arranged so as to be opposed to the current collector 1. A nitrogen gas with a pressure of 2 MPa, having been heated to about 300° C., was introduced from a gas introduction inlet 4 of the spray gun 3 into the spray gun 3. The temperature of the nitrogen gas released from the spray gun 3 was almost equivalent to room temperature. Further, the silicon particles 2 were introduced from a powder introduction inlet 5 of the spray gun 3. The silicon particles 2 were accelerated by the nitrogen gas having been transformed into a high-speed gas current in the spray gun 4, to be brought into collision with the current collector 1, along with the high-speed gas current. At this time, the nature of the interface between the silicon particles 2 and the current collector 1 was changed by kinetic energy of the particles to lead to binding between the silicon particles 2 and the surface of the current collector 1, and as a result, the silicon particles 2 were firmly bonded to the surface of the current collector 1. Moreover, since the kinetic energy also changes into heat, the temperatures of the current collector 1 and the support plate 7 increased, but those increased temperatures were still far lower than the melting point of silicon.

As shown in FIG. 2, the spray gun 3, having been attached to the front-end of a robot arm, was shifted at a rate of 60 cm/minute, taking a zigzag path on the surface of the current collector 1, to scan a region of 3.5 cm×5.5 cm so that the silicon particles were deposited on this region. It was confirmed that, as shown in FIG. 2, the shift of the spray gun in the lateral direction in a region with a width of 5.5 cm results in deposition of the silicon particles in a region of 5.5 cm×0.2 cm.

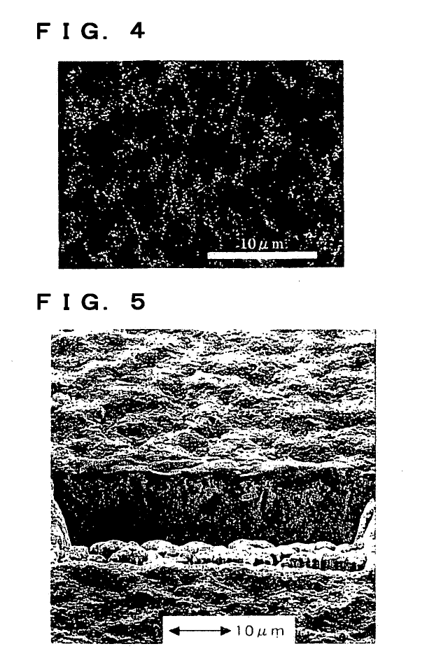

In the electrode as thus produced, the silicon particles were very firmly bonded to the surface of the copper foil as the current collector. FIGS. 3 and 4 are plan views of the surface of the produced electrode when observed with an electron probe micro-analyzer (EPMA). In FIG. 3, a brightly shining portion is a region where Si is present, while in FIG. 4, a brightly shining portion is a region where Cu is present. It is revealed from FIGS. 3 and 4 that, although almost the entire surface of the current collector is coated with the silicon particles, there exists a portion in which the copper foil is exposed to the surface.

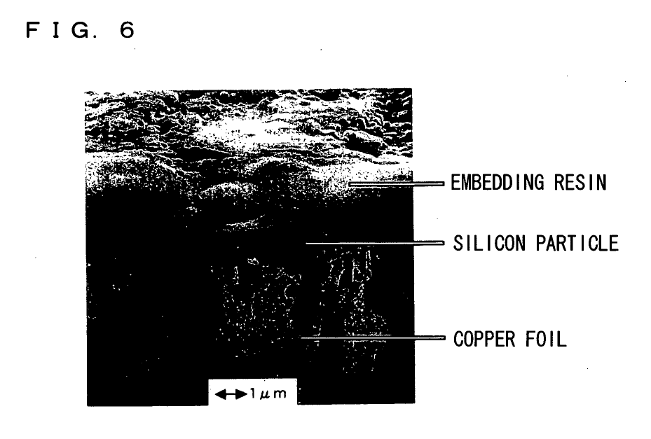

FIG. 5 is a SIM image obtained by FIB-SIM observation after coating of the surface of the above-mentioned electrode with an embedding resin. FIG. 6 is an enlarged view of FIG. 5. FIB-SIM observation is a method comprising processing a cross section with a focused ion beam (FIB) so as to be exposed and observing this cross section using a scanning ion microscope (SIM).

It is found that, as apparent from FIGS. 5 and 6, a concave portion is formed on the current collector surface by collision of the silicon particle with the current collector surface, and the silicon particle is bonded to the current collector surface in a state where the bottom of the silicon particle is imbedded in the concave portion. Further, silicon fine particles are present on the periphery of the concave portion, and it is considered that those fine particles were contained in a raw material from the beginning or are pieces of the silicon particles broken due to the collision.

As clear from FIGS. 5 and 6, it is considered that one layer of the silicon particles is deposited on the current collector surface.

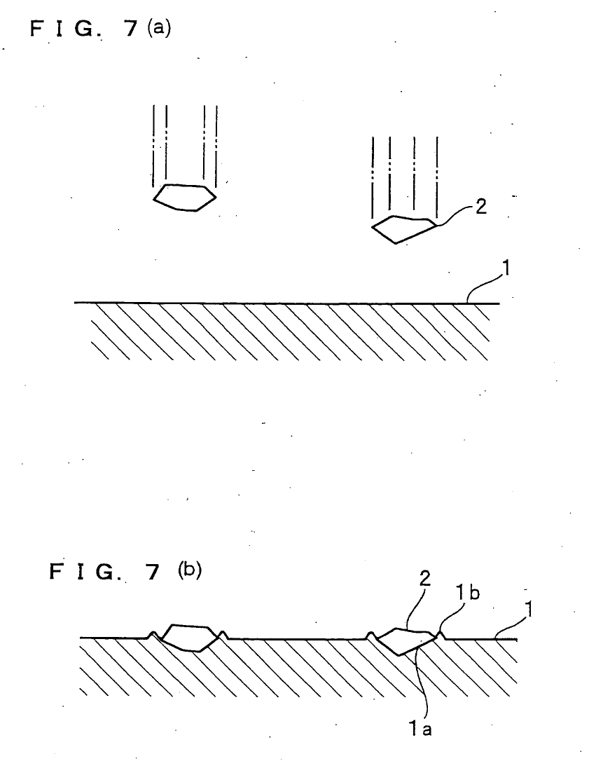

FIG. 7 is a sectional view for explaining a mechanism to bond the silicon particle to the current collector surface. As shown in FIG. 7(a), the active material particles 2 dispersed in the gas current are sprayed onto the current collector 1, along with the gas current, to be brought into collision with the surface of the current collector 1. As shown in FIG. 7(b), the surface of the current collector 1 was plastically transformed, due to the collision of the active material particle 2, to have the concave portion 1a. The active material particle 2 is arranged in a state where the bottom thereof is imbedded in the concave portion 1a, and the active material particle 2 is bonded to the surface of the current collector 1 in this state. Moreover, on the periphery of the concave portion 1a, the convex portion 1b is present which was formed at the time when the concave portion 1a was formed.

By dissolving the obtained electrode in an acid and then analyzing the dissolved electrode with inductively coupled plasma (ICP), a quantity of silicon deposited on the copper foil was determined to be 0.12 mg per 1 cm² of the copper foil. Since it took 0.09 minutes for the spray gun to be shifted by 5.5 cm and a thin film of 5.5 cm×0.2 cm was produced by this shift, it is concluded that silicon was deposited by cold spraying method in the region of 5.5 cm×0.2 cm at a rate of 1.44 mg/minute.

The obtained electrode was cut into a size of 2 cm×2 cm, which was equipped with a tab, to complete production of an electrode.

[Preparation of Electrolytic Solution]

In a mixed solvent of ethylene carbonate (EC) and diethyl carbonate (DEC) at a volume rate of 1:1, LiPF₆ was dissolved at a ratio of 1.0 mol/litter, to prepare an electrolytic solution.

[Production of Beaker Cell]

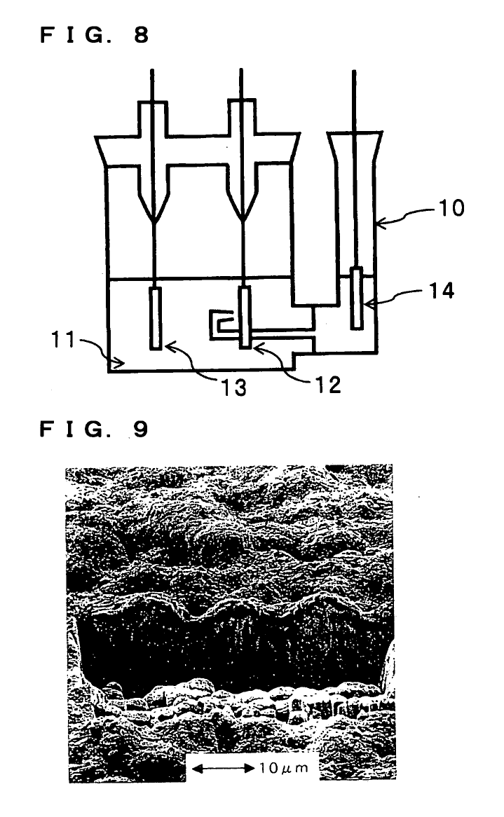

Using the above-mentioned electrode as a working electrode, molded lithium metal as a counter electrode as well as a reference electrode, and the above-mentioned electrolytic solution as an electrolytic solution, a three-pole type beaker cell shown in FIG. 8 was produced. In the beaker cell shown in FIG. 8, an electrolytic solution 11 has been put in a glass beaker 10, and a working electrode 12, a counter electrode 13 and a reference electrode 14 have been immersed in the electrolytic solution 11.

[Charge/Discharge Cycle Test]

The above-mentioned beaker cell was subjected to a charge/discharge cycle test under the following conditions:

1st to 3rd Cycles

Charge condition: 0.1 mA, with final voltage of 0 V

Discharge condition: 0.1 mA, with final voltage of 2 V (equivalent to discharge of 0.06 It)

4th to 33rd Cycles

Charge condition: 1 mA, with final voltage of 0 V→0.5 mA, with final voltage of 0 V→0.1 mA, with final voltage of 0 V

Discharge condition: 1 mA, with final voltage of 2 V (equivalent to discharge of 0.6 It)

34th Cycle

Charge condition: 1 mA, with final voltage of 0 V→0.5 mA, with final voltage of 0 V→0.1 mA, with final voltage of 0 V

Discharge condition: 1.6 mA, with final voltage of 2 V (equivalent to discharge of 1 It)

35th Cycle

Charge condition: 1 mA, with final voltage of 0 V→0.5 mA, with final voltage of 0 V→0.1 mA, with final voltage of 0 V

Discharge condition: 3.2 mA, with final voltage of 2 V (equivalent to discharge of 2 It).

36th Cycle

Charge condition: 1 mA, with final voltage of 0 V→0.5 mA, with final voltage of 0 V→0.1 mA, with final voltage of 0 V

Discharge condition: 4.8 mA, with final voltage of 2 V (equivalent to discharge of 3 It).

37th Cycle

Charge condition: 1 mA, with final voltage of 0 V→0.5 mA, with final voltage of 0 V→0.1 mA, with final voltage of 0 V

Discharge condition: 0.16 mA, with final voltage of 2 V (equivalent to discharge of 0.1 It)

38th to 40th Cycles

Charge condition: 1 mA, with final voltage of 0 V→0.5 mA, with final voltage of 0 V→0.1 mA, with final voltage of 0 V

Discharge condition: 1 mA, with final voltage of 2 V (equivalent to discharge of 0.6 It)

The measurement results are shown in Table 1, along with measurement results of Example 2 below.

It is to be noted that a capacity maintenance ratio was obtained by comparing a discharge capacity at each cycle with a discharge capacity at the first cycle. Further, a discharge capacity at the 34th cycle was used as a discharge capacity of 1 It. A discharge capacity at the 35th cycle was used as a discharge capacity of 2 It. A discharge capacity at the 36th cycle was used as a discharge capacity of 3 It. A discharge capacity at the 37th cycle was used as the discharge capacity of 0.1 It.

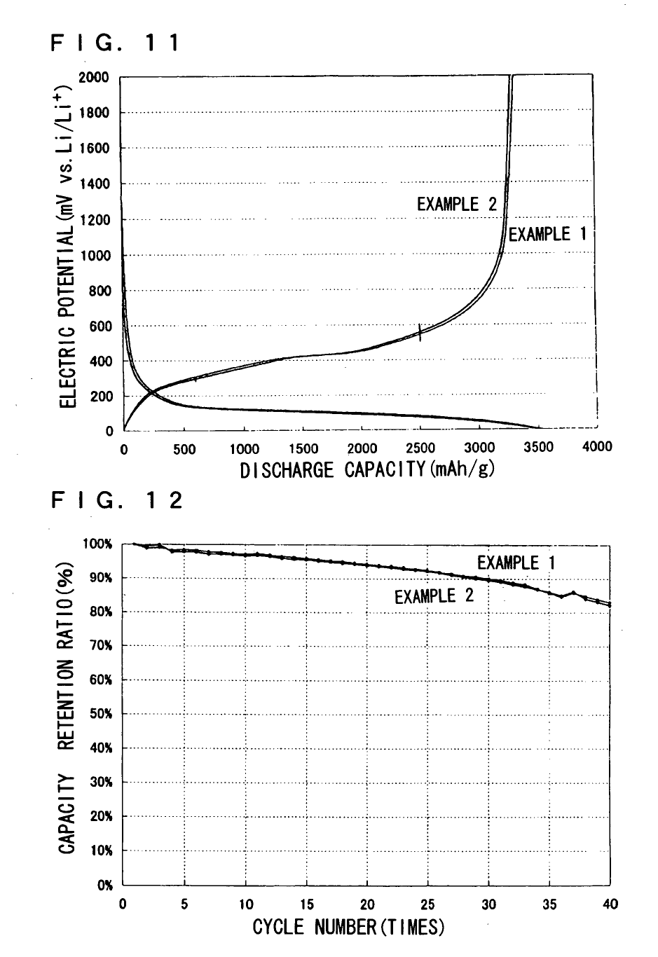

Moreover, discharge curves at the first cycle are shown in FIG. 11, and changes in discharge capacity with cycles are shown in FIG. 12.

### EXAMPLE 2

[Production of Electrode by Cold Spraying Method, Using Silicon as Active Material]

Silicon particles were allowed to adhere to the current collector surface by cold spraying method to produce an electrode in the same manner as in Example 1 except that the electrolytic copper foil was wrapped around the support plate with the roughened surface of the electrolytic copper foil on the front side in order to allow the silicon particles to adhere to the roughened surface side of the copper foil.

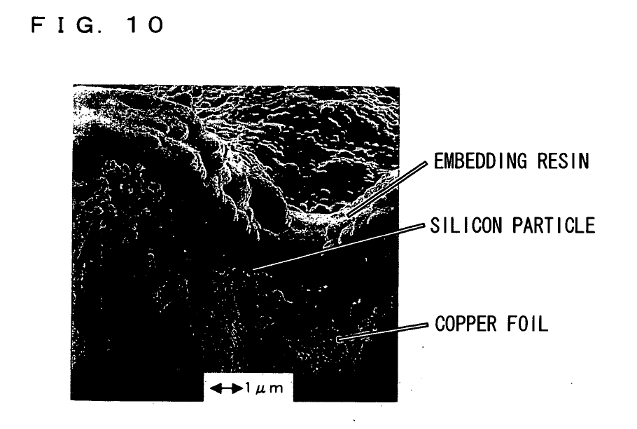

Also in the electrode obtained in the present example, the silicon particles were very firmly bonded to the current collector. FIGS. 9 and 10 are sectional views obtained by FIB-SIM observation of the cross section of the resultant electrode. It is found that, as apparent from FIGS. 9 and 10, the silicon particles adhere along the concavity and convexity of the current collector surface. In comparison between the concave portion and the convex portion on the current collector surface, it appears that a comparatively larger quantity of silicon particles have adhered to the concave portion than to the convex portion.

Since the thickness of the adhering silicon particles is about 1 μm, it appears that one layer of the silicon particles has been deposited on the current collector surface.

By dissolving the electrode in an acid and then analyzing the dissolved electrode with the ICP, the quantity of the silicon particles deposited on the current collector surface was measured to be 0.17 mg per 1 cm² of the copper foil. It was thus revealed that, although the electrode was produced under the same conditions as in Example 1, a greater quantity of silicon was deposited than in the case of Example 1. This is presumably because the quantity of the silicon particles to adhere to the surface increased with increase in area of the current collector surface due to formation of large concave and convex portions on the surface.

Since it took 0.09 minutes for the spray gun to be shifted by 5.5 cm and the silicon particles were deposited in a region of 5.5 cm×0.2 cm by this shift, it is concluded that the silicon particles were deposited by cold spraying method in the region of 5.5 cm×0.2 cm at a rate of 2.04 mg/minute.

The obtained electrode was cut into a size of 2 cm×2 cm, which was equipped with a tab, to complete production of an electrode.

[Preparation of Electrolytic Solution]

An electrolytic solution was prepared in the same manner as in Example 1.

[Production of Beaker Cell]

A beaker cell was produced in the same manner as in Example 1.

[Charge/Discharge Cycle Test]

The above-mentioned beaker cell was subjected to a charge/discharge cycle test under the following conditions:

1st to 3rd Cycles

Charge condition: 0.1 mA, with final voltage of 0 V

Discharge condition: 0.1 mA, with final voltage of 2 V (equivalent to discharge of 0.05 It)

4th to 33rd Cycles

Charge condition: 1 mA, with final voltage of 0 V→0.5 mA, with final voltage of 0 V→0.1 mA, with final voltage of 0 V

Discharge condition: 1 mA, with final voltage of 2 V (equivalent to discharge of 0.5 It)

34th Cycle

Charge condition: 1 mA, with final voltage of 0 V→0.5 mA, with final voltage of 0 V→0.1 mA, with final voltage of 0 V

Discharge condition: 2.2 mA, with final voltage of 2 V (equivalent to discharge of 1 It)

35th Cycle

Charge condition: 1 mA, with final voltage of 0 V→0.5 mA, with final voltage of 0 V→0.1 mA, with final voltage of 0 V

Discharge condition: 4.4 mA, with final voltage of 2 V (equivalent to discharge of 2 It).

36th Cycle

Charge condition: 1 mA, with final voltage of 0 V→0.5 mA, with final voltage of 0 V→0.1 mA, with final voltage of 0 V

Discharge condition: 6.6 mA, with final voltage of 2 V (equivalent to discharge of 3 It).

37th Cycle

Charge condition: 1 mA, with final voltage of 0 V→0.5 mA, with final voltage of 0 V→0.1 mA, with final voltage of 0 V

Discharge condition: 0.22 mA, with final voltage of 2 V (equivalent to discharge of 0.1 It)

38th to 40th Cycles

Charge condition: 1 mA, with final voltage of 0 V→0.5 mA, with final voltage of 0 V→0.1 mA, with final voltage of 0 V

Discharge condition: 1 mA, with final voltage of 2 V (equivalent to discharge of 0.05 It)

The measurement results are shown in Table 1, along with the measurement results of Example 1.

TABLE 1

| | | | | | | Discharge | Discharge |
|---|---|---|---|---|---|---|---|
| | | | | | | Capacity | Capacity |
| | | | | | Discharge | of | of |
| | | | Charge/ | Capacity | Capacity of | 2 It/ | 3 It/ |
| | Charge | Discharge | Discharge | Retention | 1 It/ | Discharge | Discharge |
| | Capacity | Capacity | Efficiency | Ratio | Discharge | Capacity | Capacity |
| | at 1st | at 1st | at 1st | at 33rd | Capacity of | of | of |
| | Cycle | Cycle | Cycle | Cycle | 0.1 It | 0.1 It | 0.1 It |
| | (mAh/g) | (mAh/g) | (%) | (%) | (%) | (%) | (%) |
| Example 1 | 3529 | 3317 | 94 | 88 | 101 | 100 | 99 |
| Example 2 | 3511 | 3288 | 94 | 88 | 101 | 100 | 99 |

It is found that, as apparent from the results shown in Table 1 and FIG. 11, each of the electrodes obtained in Examples 1 and 2 can function as a negative electrode of a lithium secondary battery. It is also found that, as apparent from the results shown in Table 1 and FIG. 12, the electrodes of Examples 1 and 2 have favorable charge/discharge cycle characteristics as well as favorable load characteristics.

### COMPARATIVE EXAMPLE 1

[Production of Silicon Thin Film Electrode by Sputtering Method]

On a surface of a rolled foil as a current collector, made of a heat-resisting copper alloy (zirconium copper alloy) with a roughened surface, an amorphous silicon thin film with a size of 20 cm×50 cm was deposited by sputtering method, to produce a silicon thin film electrode. Conditions for forming the thin film are shown in Table 2. Specifically, After vacuum pumping of a chamber to 1×10⁻⁴ Pa, argon (Ar) was introduced into the chamber to stabilize gas pressure. With the gas pressure in a stable state, direct current pulse voltage was applied to a silicon sputtering source to deposit the amorphous silicon thin film on the current collector surface.

The quantity of silicon deposited was 1165 mg. It is thus considered that 1.28 mg of silicon was deposited in the area of 5.5 cm×0.2 cm, which is the same area as those in Examples 1 and 2. In the present comparative example, the time required for the film formation was 146 minutes, and the same length of time was required for producing the thin film of 5.5 cm×0.2 cm because the film formation area is unrelated to the film formation time in sputtering method. Accordingly, the silicon thin film of 5.5 cm×0.2 cm is concluded to have been produced at a rate of 0.0088 mg/minute by sputtering method.

The obtained thin film was cut into a size of 2 cm×2 cm along with the current collector, which was equipped with a tab, to complete production of an electrode.

TABLE 2

| | |
|---|---|
| DC Pulse Frequecy | 100 kHz |
| DC Pulse Width | 1856 ns |
| DC Pulse Electric Power | 2000 W |
| Argon Flow Rate | 60 sccm |
| Gas Pressure | 2˜2.5 × 10⁻¹ Pa |
| Deposition Time | 146 min |
| Film Thickness | 5 μm |

[Preparation of Electrolytic Solution]

An electrolytic solution was prepared in the same manner as in Example 1.

[Production of Beaker Cell]

A beaker cell was produced in the same manner as in Example 1.

[Charge/Discharge Cycle Test]

The above-mentioned beaker cell was subjected to a charge/discharge cycle test under the following conditions:

1st to 5th Cycles

Charge condition: 1 mA, with final voltage of 0 V

Discharge condition: 1 mA, with final voltage of 2 V (equivalent to discharge of 0.26 It)

### COMPARATIVE EXAMPLE 2

[Production of Silicon Thin Film Electrode by Vapor Deposition Method]

On a surface of a rolled copper foil (thickness: 26 μm) with a roughened surface as a current collector, an amorphous silicon thin film with a size of 10 cm×60 cm was deposited by electron beam vapor deposition method. As a vapor deposition material, small granular silicon (99.999%) was used. Conditions for vapor deposition are shown in Table 3.

The quantity of silicon deposited was 792 mg. It is thus considered that 1.45 mg of silicon was deposited in the area of 5.5 cm×0.2 cm, which is the same area as those in Examples 1 and 2. In the present comparative example, the time required for the film formation was 30 minutes, and the same length of time was required for producing the thin film of 5.5 cm×0.2 cm because the film formation area is unrelated to the film formation time in vapor deposition method. Accordingly, the silicon film of 5.5 cm×0.2 cm is concluded to have been produced at a rate of 0.048 mg/minute by vapor deposition method.

The obtained thin film was cut into a size of 2 cm×2 cm along with the current collector, which was equipped with a tab, to complete production of an electrode.

TABLE 3

| | |
|---|---|
| Electron Beam Acceleration Voltage | 5 kV |
| Electron Beam Current | 100 mA |
| Vapor Deposition Atmosphere | <10⁻⁴ Pa |
| Deposition Time | 30 min |
| Film Thickness | 6 μm |

[Preparation of Electrolytic Solution]

An electrolytic solution was prepared in the same manner as in Example 1.

[Production of Beaker Cell]

A beaker cell was produced in the same manner as in Example 1.

[Charge/Discharge Cycle Test]

The above-mentioned beaker cell was subjected to a charge/discharge cycle test under the following conditions:

1st to 5th Cycles

Charge condition: 1 mA, with final voltage of 0 V

Discharge condition: 1 mA, with final voltage of 2 V (equivalent to discharge of 0.26 It)

### COMPARATIVE EXAMPLE 3

[Production of Silicon Thin Film Electrode by Thermal Spraying Method]

On a surface of an electrolytic copper foil (thickness: 35 μm) with a roughened surface as a current collector, a silicon thin film was deposited by plasma thermal spraying method. Since detailed conditions for thermal spraying are not known, a rate for producing the silicon thin film could not be calculated like the case of Examples 1 and 2 and Comparative Examples 1 and 2.

The obtained thin film along with the current collector was cut into a size of 2 cm×2 cm, which was equipped with a tab, to complete production of an electrode.

[Preparation of Electrolytic Solution]

An electrolytic solution was prepared in the same manner as in Example 1.

[Production of Beaker Cell]

A beaker cell was produced in the same manner as in Example 1.

[Charge/Discharge Cycle Test]

The above-mentioned beaker cell was subjected to a charge/discharge cycle test under the following conditions:

1st to 5th Cycles

Charge condition: 0.1 mA, with final voltage of 0 V

Discharge condition: 0.1 mA, with final voltage of 2 V

The rate for forming a thin film with a size of 5.5 cm×0.2 cm, the discharge capacity at the first cycle, the discharge capacity at the fifth cycle, and the capacity retention ratio at the fifth cycle, measured in each of Examples 1 and 2 and Comparative Examples 1 to 3, are shown in

TABLE 4

| | | Rate for | | | |
|---|---|---|---|---|---|
| | | Producing | | | |
| | | Thin | | | |
| | | Film with | Discharge | Discharge | Capacity |
| | | Size of | Capacity | Capacity | Retention |
| | | 5.5 × 0.2 | at 1st | at 5th | Ratio at |
| | Production | cm | Cycle | Cycle | 5th Cycle |
| | Method | (mg/min) | (mAh/g) | (mAh/g) | (%) |
| Example 1 | Cold | 1.44 | 3317 | 3245 | 98 |
| | Spraying | | | | |
| Example 2 | Cold | 2.04 | 3288 | 3238 | 98 |
| | Spraying | | | | |
| Comparative | Sputtering | 0.0088 | 3333 | 3283 | 98 |
| Example 1 | | | | | |
| Comparative | Vapor | 0.048 | 516 | 150 | 29 |
| Example 2 | Deposition | | | | |
| Comparative | Thermal | — | 142 | 112 | 79 |
| Example 3 | Spraying | | | | |

It is found that, as apparent from the results shown in Table 4, the electrodes can be produced at faster rates by cold spraying method than by sputtering method or vapor deposition method. It is also found that the electrode produced by cold spraying method has excellent charge/discharge cycle characteristics as compared with the electrode produced by vapor deposition method or thermal spraying method.

According to the manufacturing method of the present invention, the chemical battery electrode can be manufactured using the active material particles such as silicon particles without manufacturing the slurry. In addition, it is clear that the manufacturing method according to the present invention is excellent in productivity as compared with the sputtering method and evaporation method.

[Evaluation of State of Electrode After Charge/Discharge Cycles]

The electrodes of Examples 1 and 2 were evaluated by XRD (X-ray diffraction), SIM observation of the electrode surface, and FIB-SIM observation of the electrode cross section.

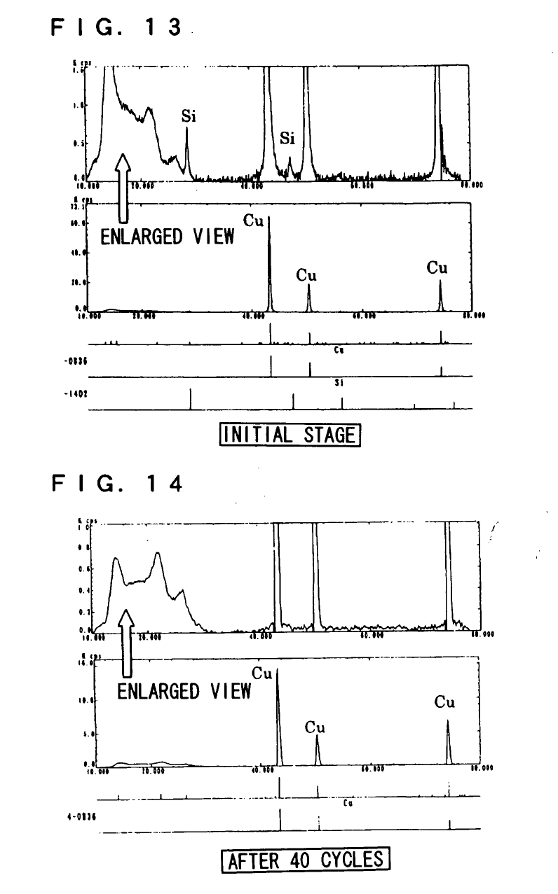

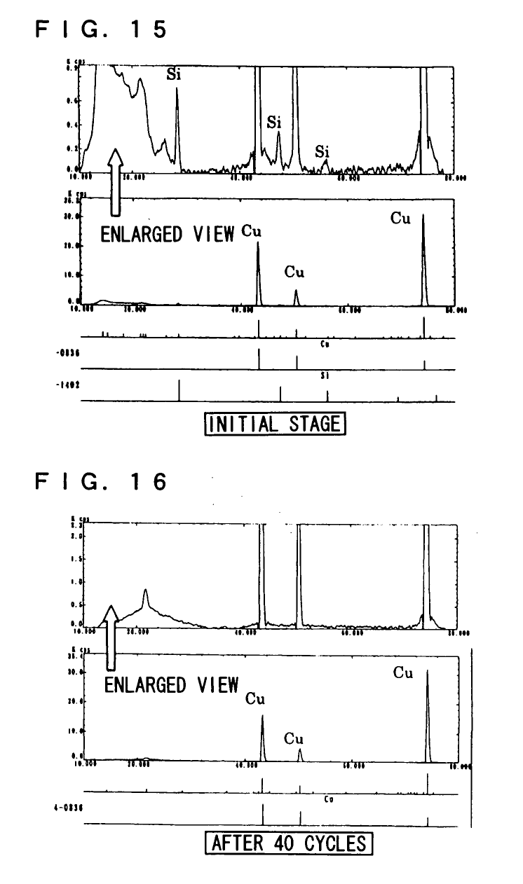

FIG. 13 is a view showing an XRD pattern of the electrode prior to the charge/discharge cycles in Example 1. FIG. 14 is a view showing an XRD pattern of the electrode after the charge/discharge cycles (40 cycles) in Example 1. FIG. 15 is a view showing an XRD pattern of the electrode prior to the charge/discharge cycles in Example 2. FIG. 16 is a view showing an XRD pattern of the electrode after the charge/discharge cycles (40 cycles) in Example 2.

As apparent from the comparison between FIGS. 13 and 14 and the comparison between FIGS. 15 and 16, in the electrodes of Example 1 and 2, the presence of crystalline silicon was confirmed prior to the charge/discharge cycles, but not confirmed after the charge/discharge cycles. It is therefore considered that silicon was crystalline prior to the charge/discharge cycles, but is substantially amorphous after the charge/discharge cycles.

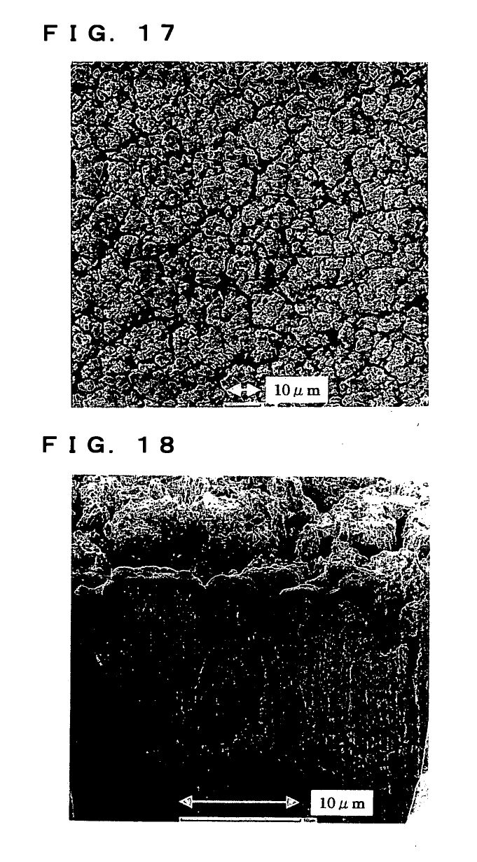

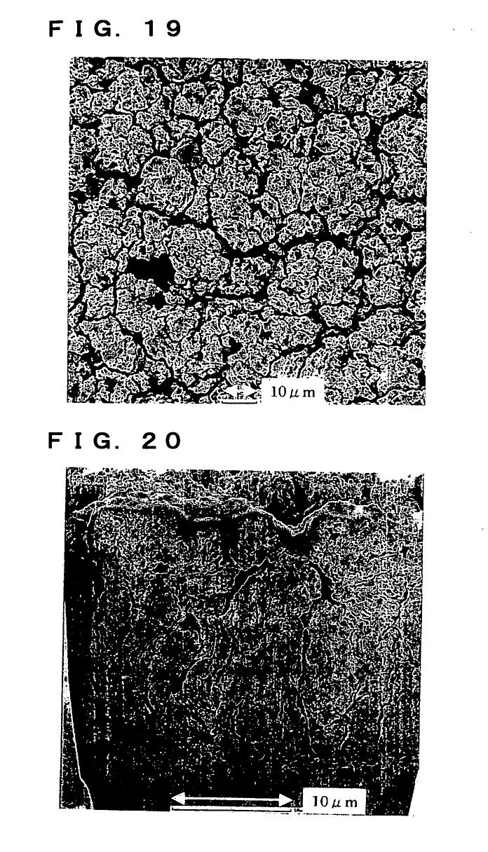

FIG. 17 shows a SIM image of the surface of the electrode in Example 1. FIG. 18 shows an FIB-SIM image of the cross section of the electrode in Example 1. FIG. 19 shows a SIM image of the surface of the electrode in Example 2. FIG. 20 shows an FIB-SIM image of the cross section of the electrode in Example 2. Each of FIGS. 17 to 20 shows the state of the electrode after the charge/discharge cycles.

It is found that, as clear from FIGS. 17 to 20, the particles on the current collector surface expand in the longitudinal direction to have a columnar structure after the charge/discharge cycles. Moreover, the inside of the columnar structure is porous, which is considered to result in large expansion of the silicon particles in the longitudinal direction. It is further thought that favorable charge/discharge cycle characteristics were obtained because the bottom of the particle is bonded to the current collector surface and this bonding state is maintained.

### EXAMPLE 3

[Production of Electrode by Cold Spraying Method, Using Mixture of Silicon Particles and Tin Particles]

In Examples 1 and 2 where only the silicon particles were used as the active material particles as above described, one layer of the silicon particles, namely a layer of the silicon particles with the thickness of only one silicon particle, is considered to be deposited on the copper foil. This is presumably because the silicon particles are difficult to bind by cold spraying method, and after substantial coating of the copper foil surface with the silicon particles, the silicon particle being brought into collision with the copper foil surface does not adhere to the top of the silicon particle and drops off. Therefore, adjustment of the sizes of the active material particles by utilizing deposition of the particles with only one-particle thickness enables control of the quantity of the active material particles to adhere to the current collector surface.

Further, as an example of another method for adjusting the quantity of the active material particles to adhere, a method can be cited in which particles composed of a material having ductility and/or malleability are used as a binder, to deposit plural layers of the particles. In the present example, tin particles were used as the particles composed of the material having ductility and/or malleability, and particles of mixture of the silicon particles and the tin particles were allowed to adhere to the copper foil surface by cold spraying method, to produce an electrode.

The silicon particles (average particle size: 18 μm) are mixed with the tin particles (average particle size: 8 μm) such that a mass ratio of the silicon particles to the tin particles was 8:2. The mixture was allowed to adhere to the surface of the copper foil as the current collector by cold spraying method in the same manner as in Example 1, to produce an electrode. From a difference in weight between the obtained electrode and the copper foil with the same area as that of the obtained electrode, the weight of the deposited mixture of silicon and tin was found to be 9.24 mg per 1 cm² of the copper foil. With this deposited quantity far larger than the deposited quantities in Examples 1 and 2, it was found that, when particles to be used do not have ductility and/or malleability, particles having ductility and/or malleability can be mixed therewith to serve as a binder so that plural layers of particles can be deposited.

1. A method of manufacturing a chemical battery electrode in which active material particles are attached onto a current collector comprising the steps of:
dispersing the active material particles in gas flow without melting or evaporating them;
spraying the gas flow to a current collector so that the active material particles collide with the current collector; and
bonding the active material particles on a surface of the current collector by impact force.

2. The method of manufacturing of the chemical battery electrode according to claim 1, wherein the chemical battery is a secondary battery in which charge and discharge can be performed.

3. The method of manufacturing of the chemical battery electrode according to claim 2, wherein the secondary battery is a lithium secondary battery in which charge and discharge are performed by a oxidation-reduction reaction of lithium.

4. The method of manufacturing of the chemical battery electrode according to claim 1, wherein the active material particle is metal, semiconductor or metal oxide.

5. The method of manufacturing of the chemical battery electrode according to claim 1, wherein the active material particle is an active material particle containing silicon as a main component.

6. The method of manufacturing of the chemical battery electrode according to claim 1, wherein a mixture of plural kinds of active material particles is used as the active material particles.

7. The method of manufacturing of the chemical battery electrode according to claim 1, wherein particles other than the active material particles, which are not an active material, are mixed to be used in the active material particles.

8. The method of manufacturing of the chemical battery electrode according to claim 6, wherein particles having ductility and/or malleability so as to be plastically deformed by the impact force are used as the active material particles or as the particles which are not the active material.

9. The method of manufacturing of the chemical battery electrode according to claim 1, wherein an amount of the active material particles attached on a current collector is controlled by adjusting a diameter of the active material particle.

10. The method of manufacturing of the chemical battery electrode according to claim 1, wherein at least a surface of the current collector is made of a material having ductility and/or malleability so as to be plastically deformed by the impact force.

11. The method of manufacturing of the chemical battery electrode according to claim 1, wherein at least the surface of the current collector is made of copper or a copper alloy.

12. The method of manufacturing of the chemical battery electrode according to claim 1, wherein the surface of the current collector is roughened.

13. The method of manufacturing of the chemical battery electrode according to claim 1, wherein a temperature of the current collector is controlled.

14. The method of manufacturing of the chemical battery electrode according to claim 1, wherein a gas which forms the gas flow is heated up.

15. The method of manufacturing of the chemical battery electrode according to claim 1, wherein the gas which forms the gas flow is an inert gas which does not substantially contain oxygen or an oxidizing gas.

16. The method of manufacturing of the chemical battery electrode according to claim 1, wherein the gas which forms the gas flow contains a reducing gas.

17. The method of manufacturing of the chemical battery electrode according to claim 1, wherein the gas which forms the gas flow is air.

18. A battery using the electrode which is manufactured by the manufacturing method according to claim 1.
